(19) United States
(12) Patent Application Publication
(10) Pub. No.: US 2014/0233139 A1
(43) Pub. Date: Aug. 21, 2014

(54) CLAMPING CIRCUIT AND DEVICE FOR EOS/SURGE/IEC

(71) Applicant: Fairchild Semiconductor Corporation, San Jose, CA (US)

(72) Inventor: Taeghyun Kang, Scarborough, ME (US)

(73) Assignee: Fairchild Semiconductor Corporation, San Jose, CA (US)

(21) Appl. No.: 14/184,855

(22) Filed: Feb. 20, 2014

Related U.S. Application Data
(60) Provisional application No. 61/767,061, filed on Feb. 20, 2013.

(51) Int. Cl. H02H 9/04

(52) U.S. Cl. CPC H02H 9/046
USPC 361/56

(57) ABSTRACT

This application discusses, among other things, protection methods and apparatus for integrated circuits. In an example, an apparatus to protect a circuit from transient electrical events can include a protection transistor configured to couple a terminal of the circuit to a reference potential during the transient events, and one or more diodes coupled in series between the terminal and a control node of the protection transistor, the one or more diodes configured to trigger the protection transistor at a predetermined voltage of the terminal. In some examples, the apparatus does not include a clamp diode coupled between the control node of the protection transistor and the reference potential.

CLAIM OF PRIORITY AND RELATED APPLICATIONS This application claims the benefit of priority under 35 U.S.C. §119(e) of Kang, U.S. Provisional Application Serial No. 61/767,061, titled, “CLAMPING CIRCUIT AND DEVICE FOR EOS/SURGE/IEC,” filed on Feb. 20, 2013, which hereby is incorporated by reference herein in its entirety.

### BACKGROUND

During ESD event, large currents can flow through an Integrated Circuit (IC), potentially causing damage it the IC. Semiconductor devices often have only a very small amount of series resistance between the input pad and the actual devices. When the input pad contains substantial amounts of electrostatic charges, the lack of series resistance associated with the semiconductor devices allows large amounts of electrostatic charges to pass through the circuitry for only a very short duration, resulting in very large voltage transients. Such an electrostatic discharge has proven in recent years to be a major cause contributing to the failures of a large number of semiconductor devices, and the integrated circuits containing the same. To avoid this damage, ESD protection circuits are added. Such circuits can consume significant amounts of die space.

### OVERVIEW

This application discusses, among other things, protection methods and apparatus for integrated circuits. In an example, an apparatus to protect a circuit from transient electrical events can include a protection transistor configured to couple a terminal of the circuit to a reference potential during the transient events, and one or more diodes coupled in series between the terminal and a control node of the protection transistor, the one or more diodes configured to trigger the protection transistor at a predetermined voltage of the terminal. In some examples, the apparatus does not include a clamp diode coupled between the control node of the protection transistor and the reference potential.

This overview is intended to provide a non-exclusive summary of the subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example protection circuit.

FIG. 2 illustrates generally an example protection circuit including three protection transistors.

FIG. 3 illustrates a simulation of an example protection circuit.

### DETAILED DESCRIPTION

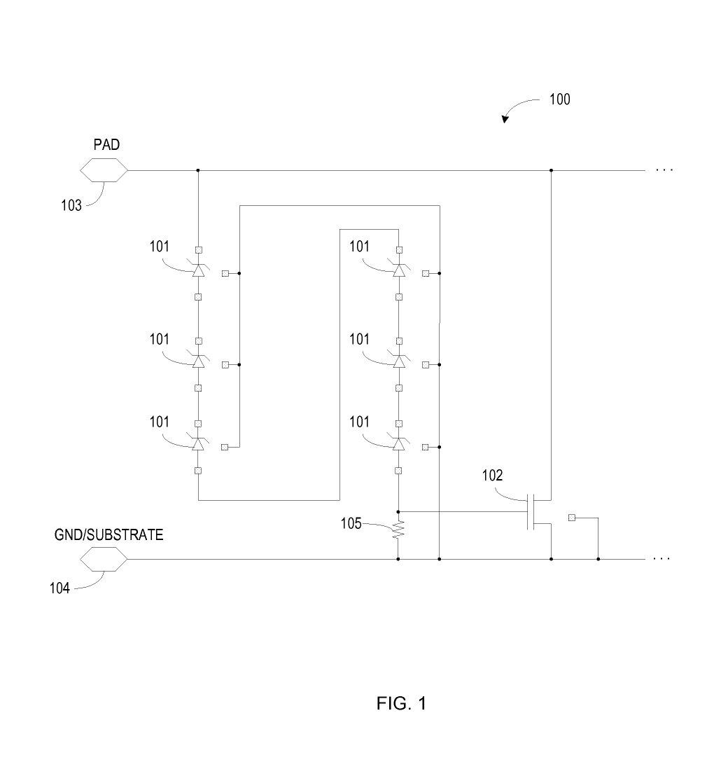

The present inventors have recognized an elegant, scalable, protection circuit for diverting energy from electrical over-stress (EOS) events, surge events, and electrostatic discharge (ESD) events. FIG. 1 illustrates generally an example protection circuit 100 including one or more diodes, such as Zener diodes 101, coupled in series between a terminal or pad (PAD) 103 of an integrated circuit (IC) and a control node of a protection transistor 102. The switched terminals of the protection transistor can be coupled between the IC pad 103 and a reference potential (GND/SUBSTRATE) 104 of the IC, such as ground. In certain examples, the IC can include the protection circuit 100. The one or more series coupled Zener diodes 101 can be configured to provide a particular trigger voltage such that as a transient voltage over the trigger voltage is received at the pad 103 the protection transistor 102 can turn on or switch from a high impedance state to a low impedance state. The low impedance state of the protection transistor 102 can divert transient energy received at the pad 103 and prevent the energy from damaging other circuitry coupled to the pad 103 or other circuitry of the IC.

The triggering voltage can be set and can be determined by the quantity and type of diodes 101 coupled between the pad 103 and the control gate of the protection transistor 102. In an example, a protection circuit 100 having six, 6.5 volt zener diodes 101 stacked in series between the pad 103 and the control gate of the protection transistor 102 can provide about a 39 volt trigger voltage at the pad 103. As such, as the voltage at the pad 103 exceeds about 39 volts, the protection transistor 102 can begin to conduct current from the pad 103 to ground 104 to protect other circuitry coupled to the pad 103. In another example, five, 6.5 volt zener diodes stacked in series between the pad and the control gate of the protection transistor can provide about a 33 volt trigger voltage at the pad. In certain example, the selection of the one or more diodes 101 can determine the trigger voltage and can also determine a gate voltage inside the Safe Operating Area of the gate oxide breakdown for both low and high voltage gate oxide technologies

In certain examples, the protection circuit 100 can include an optional pull-down resistor 105 coupled to the control node of the protection transistor 102. The pull-down transistor 105 can pull down the voltage on the control node of the protection transistor 102 during normal operation of the IC that includes the protection circuit 100.

In certain examples, the protection circuit 100 does not include a clamping diode coupled between the control node of the protection transistor 102 and the reference potential 104. In certain examples, the protection transistor 102 can include, but is not limited to, a field-effect transistor (FET). In some examples, a FET without a silicided drain can be used to provide ballast resistance. In certain examples, a FET without a silicided drain, or silicide excluded drain, can assist in allowing the protection current 100 to be shared between multiple protection circuit branches. In certain examples, an example protection circuit 100 using a protection FET does not include a resistor coupled to the drain as doing so can negate the effect of the protection circuit should the voltage drop across the resistor become significant.

In certain examples, the example protection circuit 100 can support no leakage current up to a particular non-triggering voltage at the pad. In certain examples, the protection circuit 100 can handle over 100 volt EOS/surge events, IEC6100-4-5 1.2 μsec/50 μsec pulse with 2 Ohm output impedance. In certain examples, the protection circuit 100 is capable of handling 8 kilovolts contact and 15 kilovolts air discharge per IEC61000-4-2 system level ESD.

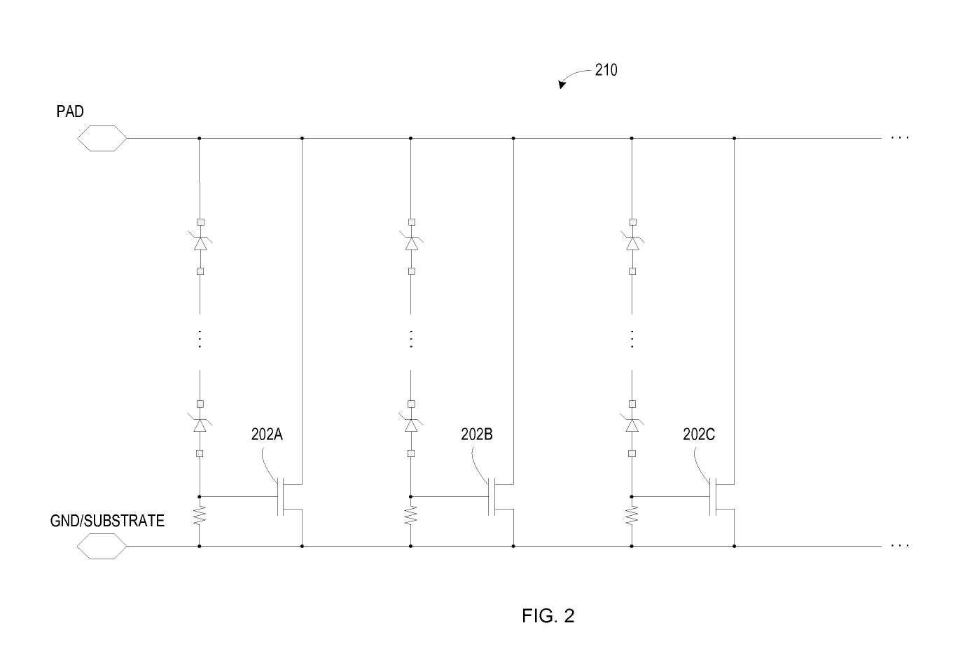

FIG. 2 illustrates generally an example protection circuit 210 including three protection transistors 202A, 202B, 202C, such as NMOS transistors. Although the same protection can be provided using a single protection transistor, diverting transient current through multiple protection transistors can significantly reduce the footprint of the protection circuit 210 because smaller protection transistors can be used. In addition, because the devices of the protection circuit 210 can be integrated proximate each other on a chip, the corresponding devices of the protection circuit 210 can have nearly identical electrical characteristics and thus react to a trigger voltage simultaneously even though each branch of the protection circuit 210 reacts independently. In some examples, the protection transistors can include lateral diffused MOS transistors. It is understood that although the illustrated examples are configured for NMOS transistors, a complimentary arrangement of the protection circuit can be configured for use with PMOS transistors.

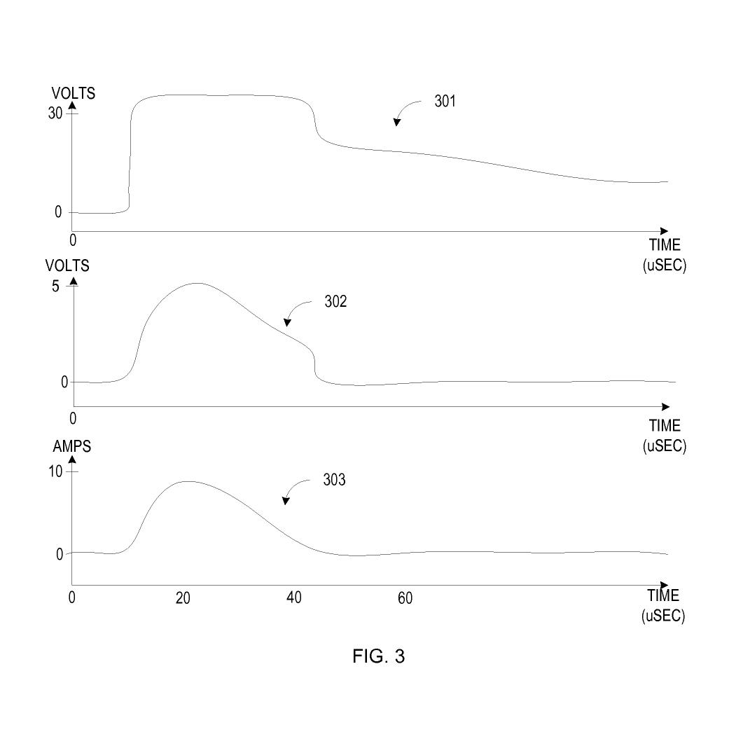

FIG. 3 illustrates a simulation of an example protection circuit. The top plot 301 shows a transient voltage waveform received at a pad of an IC including the example protection circuit. The middle plot 302 illustrates the control node voltage of the protection transistor. The bottom plot 303 illustrates the current of the protection transistor.

### Additional Notes

In Example 1, an apparatus to protect a circuit from transient electrical events can include a protection transistor configured to couple a terminal of the circuit to a reference potential during the transient events, one or more diodes coupled in series between the terminal and a control node of the protection transistor, the one or more diodes configured to trigger the protection transistor at a predetermined voltage of the terminal, and wherein the apparatus does not include a clamp diode coupled between the control node of the protection transistor and the reference potential.

In Example 2, the apparatus of Example 1 optionally includes a resistor coupled to a control gate of the protection transistor.

In Example 3, one of the one or more diodes of any one or more of Examples 1-2 optionally is positioned on a substrate, and a cathode to substrate breakdown voltage of the one diode can be greater than the predetermined voltage.

In Example 4, the protection transistor of any one or more of Examples 1-3 optionally includes a NMOS transistor.

In Example 5, a drain terminal of the NMOS transistor of any one or more of Examples 1-4 optionally is coupled directly to the terminal.

In Example 6, the NMOS transistor of any one or more of Examples 1-5 optionally is positioned on a substrate, and a drain to substrate breakdown voltage of the NMOS transistor can be greater than the predetermined voltage.

In Example 7, a protection circuit can include a plurality of protection sub-circuits coupled in parallel between a first terminal and a second terminal, the second terminal configured to couple to a reference voltage, and wherein each protection sub-circuit can include a protection transistor configured to couple a terminal of the circuit to a reference potential during the transient events, one or more diodes coupled in series between the terminal and a control node of the protection transistor, the one or more diodes configured to trigger the protection transistor at a predetermined voltage of the terminal, and wherein each protection sub-circuit does not include a clamp diode coupled between the control node of the protection transistor and the second terminal.

In Example 8, each protection transistor of any one or more of Examples 1-7 optionally includes a silicide excluded drain configured to provide a ballast resistance.

In Example 9, the protection circuit of any one or more of Examples 1-8 optionally includes a resistor coupled to each control gate of each protection transistor.

In Example 10, one diode of the one or more diodes of each protection sub-circuit of any one or more of Examples 1-9 optionally is positioned on a substrate, and a cathode to substrate breakdown voltage of the one diode can be greater than the predetermined voltage.

In Example 11, each protection transistor of any one or more of Examples 1-10 optionally includes a NMOS transistor.

In Example 12, a drain terminal of each of the NMOS transistor of any one or more of Examples 1-11 optionally is coupled directly to the first terminal.

In Example 13, each NMOS transistor of any one or more of Examples 1-12 optionally is positioned on a substrate, and a drain to substrate breakdown voltage of each NMOS transistor can be greater than the predetermined voltage.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. An apparatus to protect a circuit from transient electrical events, the apparatus comprising:
a protection transistor configured to couple a terminal of the circuit to a reference potential during the transient events;
one or more diodes coupled in series between the terminal and a control node of the protection transistor, the one or more diodes configured to trigger the protection transistor at a predetermined voltage of the terminal;
wherein the apparatus does not include a clamp diode coupled between the control node of the protection transistor and the reference potential.

2. The apparatus of claim 1, including a resistor coupled to a control gate of the protection transistor.

3. The apparatus of claim 1, wherein one of the one or more diodes is positioned on a substrate; and
wherein a cathode to substrate breakdown voltage of the one diode is greater than the predetermined voltage.

4. The apparatus of claim 1, wherein the protection transistor includes a NMOS transistor.

5. The apparatus of claim 4, wherein a drain terminal of the NMOS transistor is coupled directly to the terminal.

6. The apparatus of claim 4, wherein the NMOS transistor is positioned on a substrate; and
wherein a drain to substrate breakdown voltage of the NMOS transistor is greater than the predetermined voltage.

7. A protection circuit comprising:
a plurality of protection sub-circuits coupled in parallel between a first terminal and a second terminal, the second terminal configured to couple to a reference voltage; and
wherein each protection sub-circuit includes:
a protection transistor configured to couple a terminal of the circuit to a reference potential during the transient events;
one or more diodes coupled in series between the terminal and a control node of the protection transistor, the one or more diodes configured to trigger the protection transistor at a predetermined voltage of the terminal; and
wherein each protection sub-circuit does not include a clamp diode coupled between the control node of the protection transistor and the second terminal.

8. The protection circuit of claim 7, wherein each protection transistor includes a silicide excluded drain configured to provide a ballast resistance.

9. The protection circuit of claim 7, including a resistor coupled to each control gate of each protection transistor.

10. The protection circuit of claim 7, wherein one diode of the one or more diodes of each protection sub-circuit is positioned on a substrate; and
wherein a cathode to substrate breakdown voltage of the one diode is greater than the predetermined voltage.

11. The protection circuit of claim 7, wherein each protection transistor includes a NMOS transistor.

12. The protection circuit of claim 11, wherein a drain terminal of each of the NMOS transistor is coupled directly to the first terminal.

13. The protection circuit of claim 7, wherein each NMOS transistor is positioned on a substrate; and
wherein a drain to substrate breakdown voltage of each NMOS transistor is greater than the predetermined voltage.
